(19) United States
(12) Patent Application Publication
(10) Pub. No.: US 2018/0007100 A1
(43) Pub. Date: Jan. 4, 2018

(54) CANDIDATE PARTICIPANT RECOMMENDATION

(71) Applicant: Microsoft Technology Licensing, LLC, Redmond, WA (US)

(72) Inventor: Georgios Krasadakis, Dublin (IE)

(73) Assignee: Microsoft Technology Licensing, LLC, Redmond, WA (US)

(21) Appl. No.: 15/199,787

(22) Filed: Jun. 30, 2016

(51) Int. Cl. H04L 29/06; G06Q 10/10

(52) U.S. Cl. CPC H04L 65/403; G06Q 10/1095

(57) ABSTRACT

A computing system for organizing meetings, projects, and other collaborative engagements comprises a logic machine and a storage machine holding instructions. The instructions are executable by the logic machine to receive user input setting up a collaborative engagement, the collaborative engagement having an associated topic. One or more candidate participants are recommended for the collaborative engagement based on a candidate score for each of the one or more candidate participants. The candidate score for a particular candidate participant is computer generated and based on a topic relatedness score for the particular candidate participant and an aggregated meeting contribution score for the particular candidate participant.

### BACKGROUND

Meetings, projects, and other collaborative engagements are often organized and/or facilitated through the use of a calendar/email/task platform deployed across a company or other organization, for example via client software on distributed devices. Such a service/platform may be used to set up meetings, and invite any number of meeting participants, who may attend the meeting either in person or virtually.

### BRIEF DESCRIPTION OF THE DRAWINGS

FIG. 1 schematically shows an example collaborative engagement including several participants.

FIG. 2 schematically shows creation of a collaborative engagement based on user input.

FIG. 3 schematically shows examples factors based on which a candidate score for a candidate participant may be calculated.

FIG. 4 schematically shows comparison of an associated topic of a collaborative engagement with associated topics of other collaborative engagements.

FIG. 5 schematically shows comparison of an associated topic of a collaborative engagement with a participant expertise profile generated based on one or more participant information sources.

FIG. 6 schematically shows various factors that may contribute to an aggregated meeting contribution score.

FIG. 7 illustrates an example method for organizing meetings, projects, and other collaborative engagements.

FIG. 8 schematically shows an example computing system.

### DETAILED DESCRIPTION

Meetings can be a valuable tool for planning, sharing information, decision-making, etc. Meeting quality, however, can greatly depend on the skill, expertise, experience, temperament, etc., of those in attendance. Having the right people involved can make for a highly productive and satisfying meeting. On the other hand, meetings can be unpleasant and frustrating, or simply unproductive, when meeting participants lack relevant experience, are disinterested, have poor leadership/organizational skills, are not well-prepared, have no access to related resources, when the meeting is not well-defined (e.g., no topic/agenda set, no provided resources), etc.

Accordingly, the present discussion relates to identifying, discovering, and recommending relevant and/or valuable participants for a meeting, project, or other collaborative engagement. Such a collaborative engagement may be organized through a computerized meeting service—e.g., an email/calendar client—which may create the collaborative engagement based on user input, and automatically recommend one or more candidate participants for the collaborative engagement. In one example, these candidate participants may be recommended based on a candidate score calculated for each candidate participant. A candidate score for a particular candidate participant may be calculated based upon a variety of factors, including (1) the particular candidate participant's relevance to the meeting topic, (2) the extent to which the particular candidate participant has positively contributed to previous meetings, and/or (3) whether the candidate participant has attended meetings that are particularly relevant to the topic. Recommending meeting participants in this manner can reduce the potential for inviting low-value participants to meetings, as well as identifying and recommending potentially valuable meeting participants who would not otherwise attend.

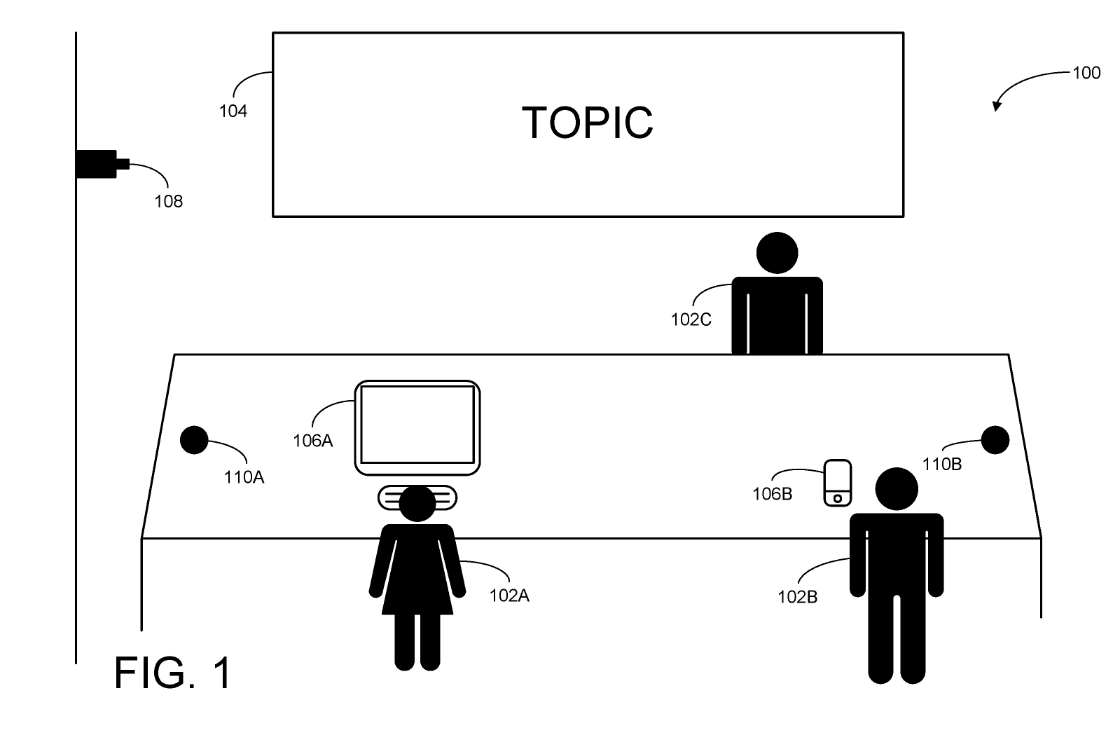

FIG. 1 schematically depicts an example collaborative engagement 100, which in many examples will be referred to as a “meeting.” It will be appreciated that “collaborative engagement” as used herein may refer to any meeting, project, or other coordinated interaction/communication between two or more individuals. A “meeting” may be any previously-scheduled interaction between two or more participants for the purpose of sharing information, planning, decision-making, brainstorming, or other forms of collaboration. Specific reference to “meetings” may occur throughout the disclosure, though it will be appreciated that the candidate participant identification and recommendation techniques described herein may be applied to any variety of collaborative engagements where appropriate, and not exclusively to interactions characterized as meetings.

As indicated, collaborative engagement 100 may include several participants 102 meeting in the same physical location. It will be appreciated that the meeting may include one or more other participants who are attending virtually, e.g., via remote participation using various devices, sensors and communication channels.

As shown, collaborative engagement 100 has an associated topic 104. As will be described below, the topic 104 may be defined in advance of the meeting by a meeting organizer, and/or automatically inferred by a computing system based on a user input creating the meeting, meeting materials provided to the computing system, etc. Furthermore, candidate meeting participants may be recommended at least in part based on their relevance to/particular expertise regarding the meeting topic. In some implementations, a single collaborative engagement may have several distinct topics. Furthermore, a single topic may refer to multiple meetings, projects, products, strategies, etc.

Also shown in FIG. 1 are two computing devices 106. Specifically, FIG. 1 shows computing device 106A, taking the form of a desktop computer, and computing device 106B, taking the form of a mobile computing device. Such computing devices may be used in various ways within the context of collaborative engagement 100. For example, computing devices 106 may facilitate two-way communication with one or more meeting participants attending the meeting virtually. Computing devices 106 may additionally/alternatively be used to view, edit, and/or share meeting materials, view information relevant to the associated topic 104, and/or view information relevant to other meeting participants 102, etc. It will be appreciated that any types and combinations of computing devices may be used in a collaborative engagement setting. For example, computing devices 106 may be desktop computers, laptop computers, mobile devices (e.g., smartphones, tablets), wearable computing devices, virtual reality (VR) or augmented reality (AR) devices, etc.

In particular, meeting participants 102 may make use of computing devices 106 to evaluate aspects of collaborative engagement 100. Specifically, computing devices 106 may be used to evaluate the collaborative engagement itself—whether the meeting began/ended on time, whether the meeting was well organized, whether the meeting was productive, etc. Similarly, computing devices 106 may be used to evaluate other meeting participants—whether they were knowledgeable about the topic, respectful during the meeting, positively contributed to the meeting experience, etc. Such evaluations may be referred to as “explicit feedback” regarding the collaborative engagement.

Computing devices 106 may be used to provide evaluations in a variety of ways. For example, during the collaborative engagement, meeting participants 102 may have the opportunity to fill out one or more evaluation forms, regarding the meeting as a whole and/or other meeting participants. Such evaluation additionally/alternatively be done before (e.g., meeting expectations, goals, relevance of invitation) and/or after the meeting. It will be appreciated that evaluations may take any suitable form, and may be as simple as giving a “thumbs up” to any aspects of the meeting that the participant enjoyed. As will be described below, evaluations provided by participants in a collaborative engagement may be used to generate evaluation data describing the quality of the subject of the evaluations—i.e., individual meeting participants and/or the meeting itself.

In addition to explicit feedback provided by meeting participants, a meeting may be evaluated via implicit feedback provided by one or more sensors that capture real-time data during the meeting. For example, computing devices 106 may include any number of sensors, and data from these sensors may be used to infer the overall quality of the meeting and/or the performance of individual meeting participants. For example, a computing device 106 may include a touch sensor, configured to detect and log touch events. Additionally, or alternatively, telemetry/instrumentation data available through a local network can be associated with a location of a meeting participant and a time of the meeting, and used to infer frequent use of a computing device during the meeting. Frequent use of a computing device during a meeting, as logged by a touch sensor, may indicate that the meeting participant was not paying sufficient attention during the meeting. Alternatively, frequent computing device use could indicate that the user was reading meeting materials, digitally interacting with other meeting participants, annotating slides while presenting to other participants, etc. Computing devices 106 may additionally or alternatively include one or more accelerometers, gyroscopes, global positioning satellite (GPS) receivers, network communication interfaces, etc., usable for collecting information regarding a meeting participant's activity during a meeting, and/or the quality of the meeting overall.

Sensor data used for evaluating meetings and/or meeting participants may additionally or alternatively be received from one or more microphones and/or cameras. For example, FIG. 1 shows a camera 108 and two microphones 110, which may be used to collect sensor data during a meeting. Additionally, or alternatively, computing devices 106 may include one or more integrated microphones/cameras usable for collecting sensor data. For example, camera 108 may be used to perform facial recognition to determine which individuals attended a meeting, interpret body language in order to determine which participants are actively engaged in the meeting, determine participant reactions to particular news/pieces of information, etc. Similarly, microphones 110 may be used to identify which participant is speaking at any given time, the relative amounts of time each participant spends speaking during a meeting, the emotional state/excitement level of each participant, determined for example by analyzing voice inflection and/or spoken word frequency, etc. Such implicit feedback may be used to evaluate the performance of each individual participant, as well as determine the overall impact/energy level of the meeting.

As indicated above, a meeting's associated topic, as well as sensor data and/or evaluation data, may be used to automatically and intelligently recommend candidate participants for any given collaborative engagement. This may be automatically done by a computer system, after the computer system receives user input to create a collaborative engagement.

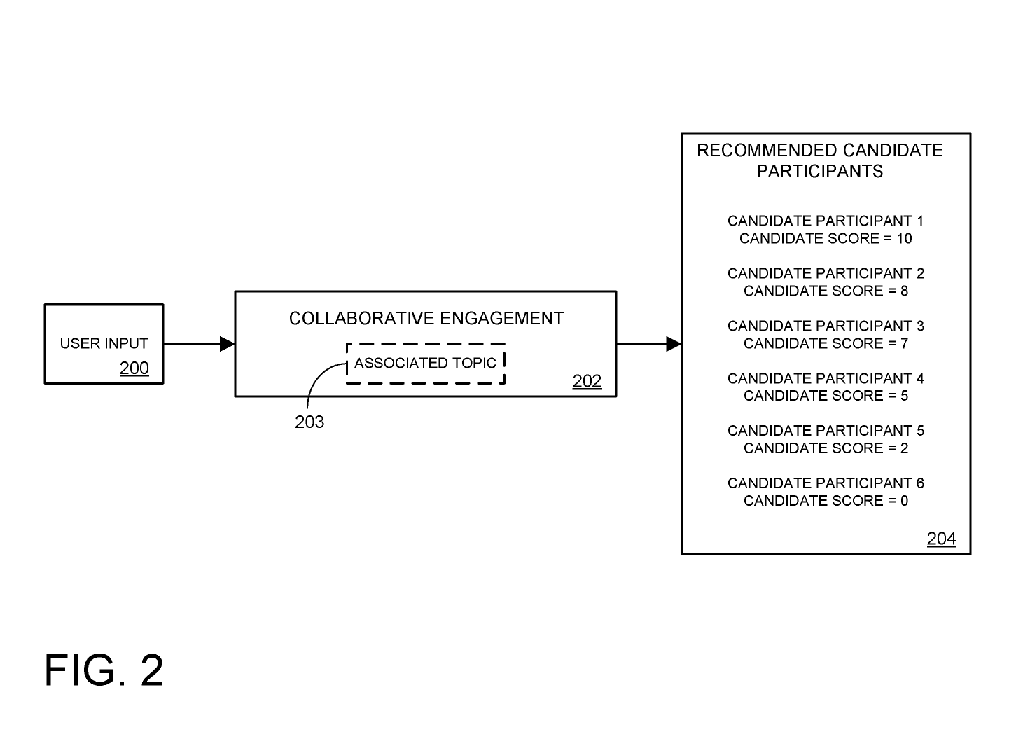

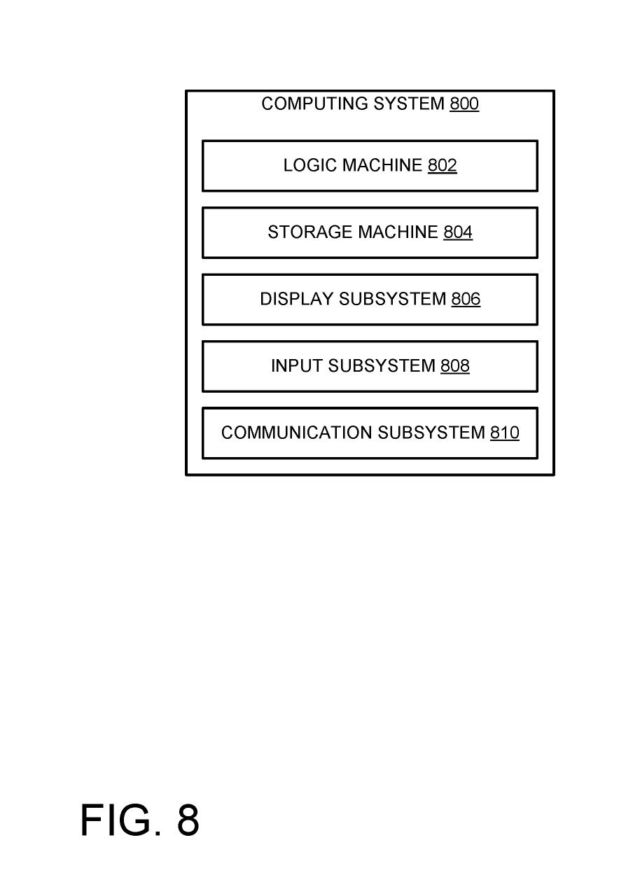

This is schematically illustrated in FIG. 2, which shows receipt of a user input 200 causing creation of a collaborative engagement 202 having an associated topic 203. This may be performed by a computing system configured to create and manage meetings, projects, and other collaborative engagements. For example, the collaborative engagement creation and participant recommendations described herein may be performed by computing system 800, described below with respect to FIG. 8.

User input 200 may be provided in a number of different ways. For example, user input may take the form of a user engaging with a meeting creation/organization interface (e.g., enterprise calendar software) to input details of a meeting, including time, place, topic, etc. Additionally, or alternatively, a computing system may create the collaborative engagement based on a spoken request from the user. Similarly, the collaborative engagement may be created based on programming that causes the computing system to automatically create a collaborative engagement under certain conditions, or automatically created based on personal calendar entries of one or more users, etc.

In some implementations, the user input may explicitly define the associated topic of the collaborative engagement. However, in other implementations, the computing system may automatically infer the topic associated with the collaborative engagement based on the user input provided by the user. For example, the associated topic may be automatically inferred based on the meeting's time, location, relationship with previous meetings, the identity/role of the meeting organizer, etc.

The associated topic of a meeting may define the nature/purpose of the meeting at any desired level of detail/specificity. For example, the associated topic may indicate that the purpose of the meeting is to generally discuss sales, or research and development, for example. Alternatively, the associated topic may define a specific product/feature/goal for discussion, a particular business strategy, or otherwise may specifically define the purpose of the meeting. An associated topic may additionally define the context of the meeting—whether the meeting is a brainstorming session, a sales call, emergency response, handling customer feedback, etc. A meeting topic may be useful information when automatically recommending candidate participants, as will be described below. Further, the context of a meeting may be considered as an additional factor when recommending participants (for example, a particular candidate may be especially helpful in brainstorming scenarios).

Upon creating a collaborative engagement based on user input, a computing system may automatically recommend one or more candidate participants for the collaborative engagement based on a candidate score for each of the one or more participants. This is schematically shown in FIG. 2, in which the computing system has created a list of recommended candidate participants 204. Each candidate participant on the list may be ranked according to a candidate score associated with the candidate participant. In some implementations, after recommending one or more candidate participants for a collaborative engagement, the computing system may automatically invite recommended candidate participants to the collaborative engagement.

It will be understood that the list of candidate participants shown in FIG. 2 is not intended to be limiting with respect to the number or nature of candidates. A computing system may recommend any number of candidate participants for a particular collaborative engagement. For example, the computing system may (1) automatically recommend a set number of participants for each collaborative engagement, (2) recommend a different number of candidate participants for each collaborative engagement, (3) present a list of all available participants ranked by candidate score, etc. In some implementations, a rationale/justification may be provided indicating why each candidate was recommended—relevant education, good team player, etc. Further, a candidate score may be expressed in any way, and calculated according to any number of factors or processing operations. In general, a candidate score may be any value or metric that allows the relative suitability of different candidate participants to a collaborative engagement to be compared.

In some implementations, additional considerations may be made when recommending a list of candidate participants in order to maintain an ideal audience/team balance for a particular collaborative engagement. For example, based on sensor data/evaluation data for candidate participants and previous meetings, a computing system may determine that a given meeting should have a certain number of participants, including one manager, two researchers, one engineer, etc. The list of recommended participants may then be generated according to these considerations.

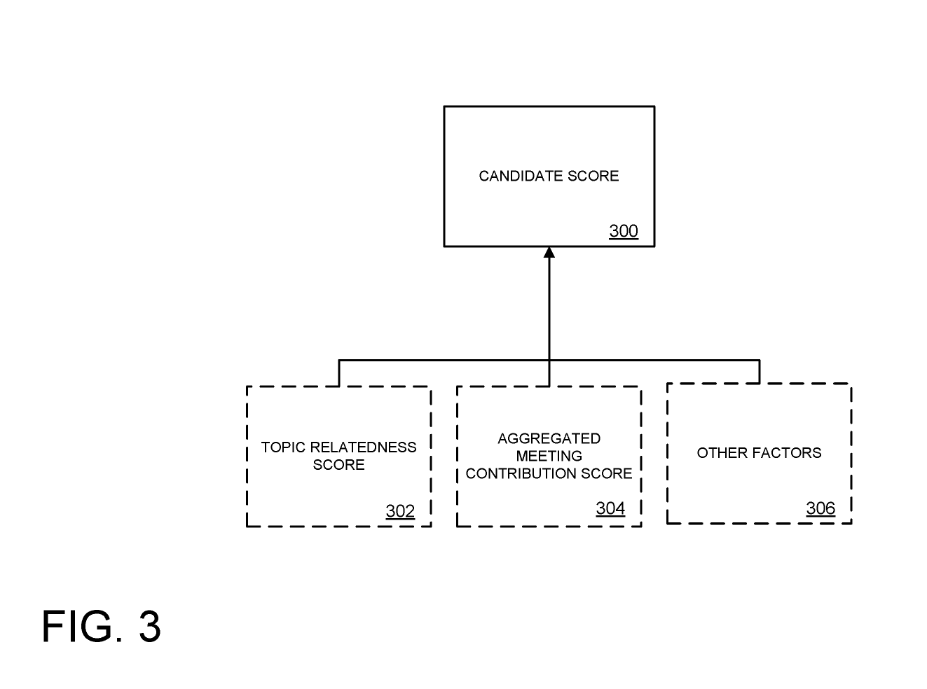

As indicated above, a variety of factors may contribute to calculating a candidate score for a particular candidate. This is schematically shown in FIG. 3, which includes an example candidate score 300. As shown, two factors contribute in this example to candidate score 300: a topic relatedness score 302 and an aggregated meeting contribution score 304. Each of these factors will be described in further detail below, and may independently affect the candidate score. For example, a candidate may have a relatively high topic relatedness score, and a relatively low aggregated meeting contribution score, thereby resulting in a modest/average candidate score (e.g., in comparison to a candidate rating high in both aspects). In general, a topic relatedness score may indicate a particular candidate's relevance to the meeting/project, as reflected by previous meetings the candidate has attended, the candidate's work history, education, publications, social media posts, etc. Similarly, the aggregated meeting contribution score may reflect any positive/negative effects the candidate has had on other meetings, according to meeting productivity, energy levels, etc.

Also shown in FIG. 3 are other factors 306 that may additionally contribute to calculation of candidate score 300. It will be appreciated that factors 306 may include a variety of information/metrics applicable to a particular candidate's suitability. For example, factors 306 may include the particular candidate's proximity to the physical meeting space/access to virtual meeting platforms, availability, general workload (current and/or anticipated), the openness of the particular candidate to receiving invitations, etc.

The specific factors contributing to candidate score 300 shown in FIG. 3 are but examples. A candidate score as described herein may be based on both a topic relatedness score and an overall meeting score, one or the other, or neither of these factors. Furthermore, a candidate score may be based on a variety of factors not explicitly described herein. In general, any suitable combination of information may serve as the basis for calculating a candidate score, and the factors described herein are only presented as examples.

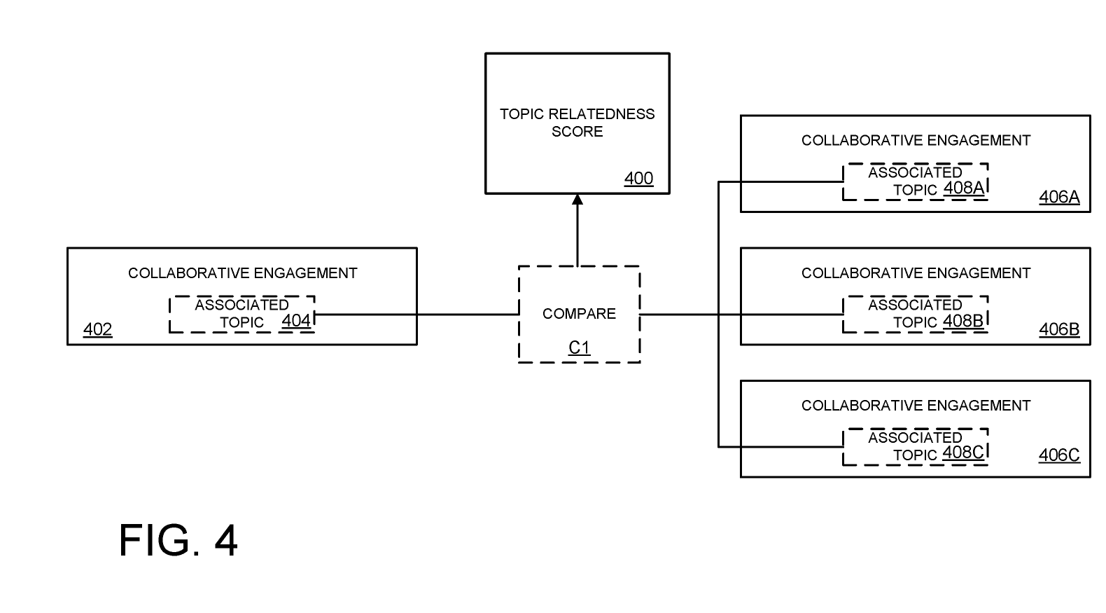

In some implementations, a topic relatedness score for a candidate, may be generated via a comparison between the associated topic of a collaborative engagement, and associated topics of meetings in which the candidate has previously participated. This is schematically illustrated in FIG. 4, which shows generation of a topic relatedness score 400. A topic relatedness score 400 may be generated for a particular candidate identified for a collaborative engagement 402 having an associated topic 404. Collaborative engagement 402 may be created in response to user input, as described above.

After creating the collaborative engagement, the computing system may generate topic relatedness score 400 by performing a comparison C1 between associated topic 404 and associated topics of one or more other meetings in which the candidate has previously participated. For example, collaborative engagements 406 shown in FIG. 4 may be meetings and/or projects in which the candidate has previously participated, and each collaborative engagement 406 may have an associated topic 408. The computing system may perform comparison C1 by evaluating similarities between associated topic 404 and the associated topics 408. This may include identifying any keywords common to associated topic 404 and one or more associated topics 408, as well as identifying similar meeting contexts, or any other details regarding a collaborative engagement's topic or subject. Accordingly, the generated topic relatedness score 400 may reflect the extent to which the candidate has attended meetings similar to the created collaborative engagement 402.

It will be appreciated that the associated topic of a created collaborative engagement may be compared to associated topics of any number of other meetings, projects, or other collaborative engagements. For example, the associated topic for a created collaborative engagement may be compared to the associated topics of all meetings in which a candidate has attended, organized, and/or otherwise participated in. Alternatively, the associated topic may only be compared to associated topics of a certain number of previous meetings, any previous meetings that took place within a particular period of time, any previous meetings organized by the same meeting organizer, etc.

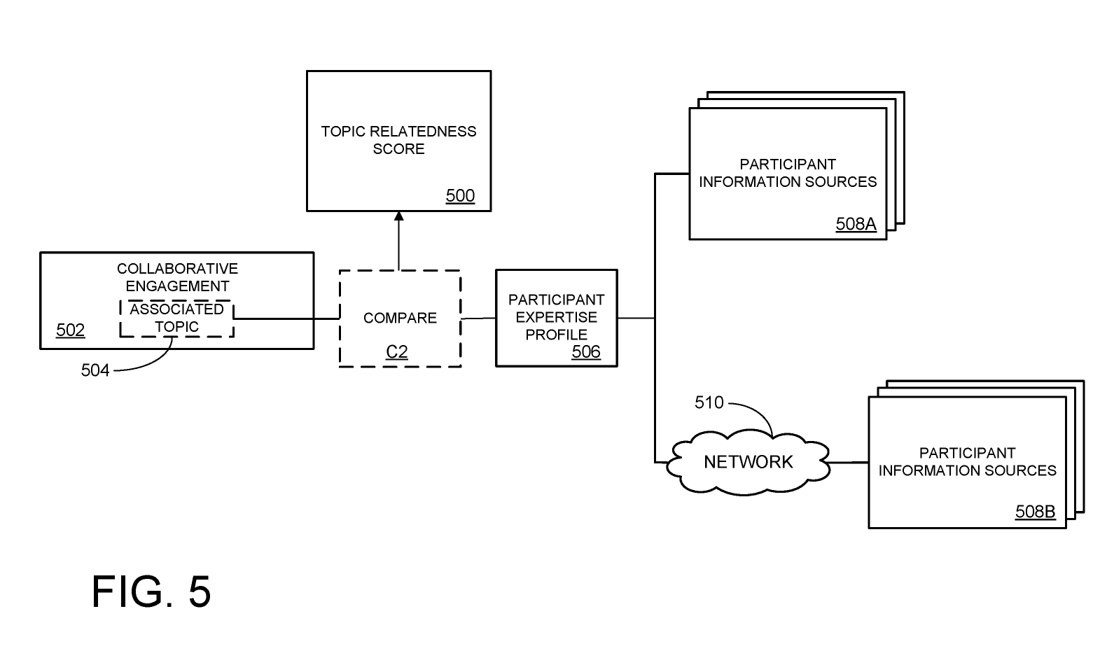

A topic relatedness score such as topic relatedness score 302 may additionally or alternatively be generated based on a comparison between the associated topic of a collaborative engagement and a participant expertise profile generated based on information obtained from one or more participant information sources. This is schematically illustrated in FIG. 5, which shows generation of a topic relatedness score 500. As with topic relatedness score 400, topic relatedness score 500 may be generated for a candidate identified for a collaborative engagement 502 having an associated topic 504, and the collaborative engagement may be created by a computing system in response to user input, as described above.

The computing system may generate topic relatedness score 500 by performing a comparison C2 between the associated topic 504 and a participant expertise profile 506, which may be generated based on information obtained from one or more participant information sources 508. Participant information sources 508 may be locally accessible on the computing system, as is the case with participant information sources 508A, and/or remotely accessible via a network 510, such as the Internet, or an internal company network, for example, in the case of participant information sources 508B.

A participant information source 508 may be any source of information relevant to a candidate's expertise, work history, interests, etc., as it pertains to the associated topic of a collaborative engagement. For example, a participant information source might include a candidate's resume, which may describe prior positions the candidate has held, the candidate's areas of education, any extracurricular interests relevant to the associated topic, etc. In some implementations, a computing system may have access to one or more application programming interfaces (APIs) allowing the computing system to access a candidate's email history, calendar, instant messaging (IM) history, their role within a company's organizational chart, awards/kudos given to the candidate by an organization hosting the meeting, any social media posts written by the candidate, any documents/publications written by the candidate, etc. Relevant information from these sources may be collected in participant expertise profile 506 and cross-referenced against associated topic 504, for example via keyword searching or natural language processing. As a result of this comparison, the computing system may generate topic relatedness score 500.

In particular, a computing system may be configured to access any profiles maintained by the candidate on social networking sites, including Facebook®, Twitter®, LinkedIn®, etc. In particular, a candidate's LinkedIn® profile may include a variety of information relevant to recommending a candidate for a meeting, including projects mentioned in the candidate's “experiences” section, patents listed, awards, professional skills, recent seminars, recommendations, professional contacts, skills endorsements, etc. Such information may be included in a participant expertise profile for the candidate, and therefore be used as a basis for recommending the candidate for a meeting.

Regardless of how a topic relatedness score is calculated—e.g., by comparing an associated topic to a participant expertise profile and/or associated topics of previous meetings, it may generally serve as an indicator of the candidate's knowledge/abilities in relation to the associated topic. Accordingly, automatically recommending candidate participants with high topic relatedness scores may serve to ensure that a meeting is attended by participants with valuable expertise pertaining to the topic, while reducing the potential for having low-value participants involved and improving the size/role balance of the meeting participants/audience.

As indicated above, a candidate score may be based at least partially on an aggregated meeting contribution score, such as aggregated meeting contribution score 304. A candidate score may be generated based on an aggregated meeting contribution score instead of and/or in addition to a topic relatedness score, as well as a variety of other factors. Further, an aggregated meeting contribution score itself may be generated by the computing system based on a wide variety of accessible information pertaining to the candidate, including previous meetings in which the candidate has participated.

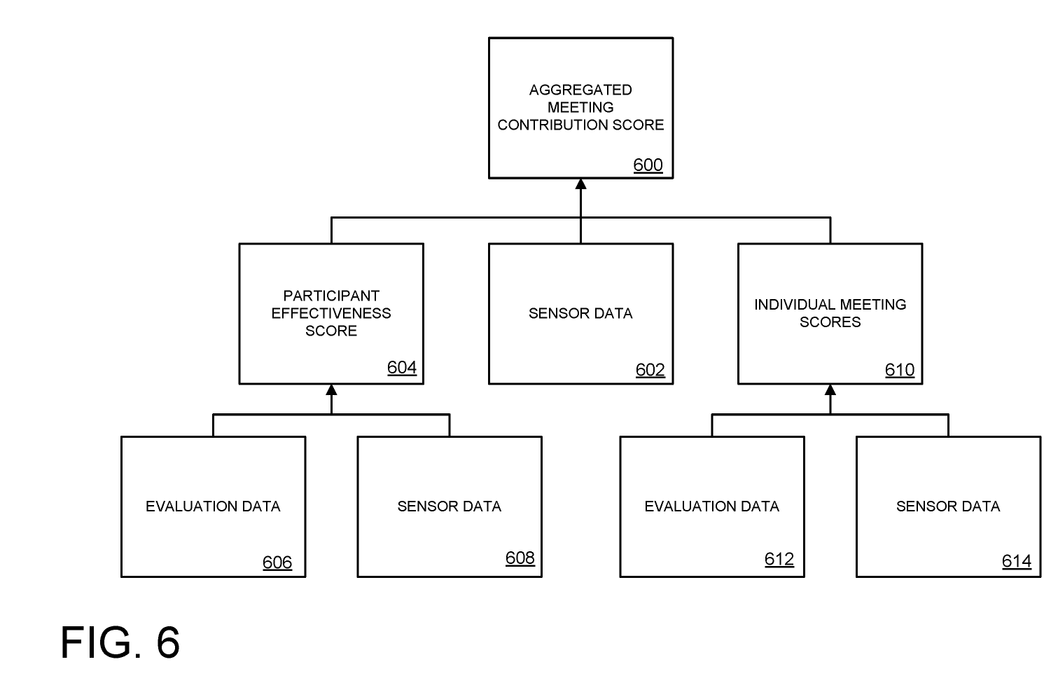

This is illustrated in FIG. 6, which schematically shows example factors upon which an aggregated meeting contribution score may be generated. For example, sensor data 602 may be automatically collected during meetings attended by the candidate, and generate the aggregated meeting contribution score based on a processing of the sensor data. As described above, sensor data may be received from one or more of a camera, a microphone, and a touch sensor. Sensor data 602 may reflect the performance of the candidate in previous meetings, and/or the quality/energy level of the meetings themselves. Accordingly, a relatively high aggregated meeting contribution score calculated based on sensor data for a candidate may generally indicate that the candidate positively contributed to previous meetings. Therefore, the candidate may be predicted to positively contribute to the created collaborative engagement.

The aggregated meeting contribution score 600 may additionally/alternatively be generated based on a participant effectiveness score 604 for the candidate, e.g., an assessment of the candidate's contributions to and performance in the meeting. For example, a computing system may receive evaluation data 606 for the candidate associated with meetings in which the candidate has previously participated. The computing system may then calculate the participant effectiveness score based on the evaluation data 606. Evaluation data may be provided by other meeting participants, as described above, and may include explicit feedback of the candidate's organizational skills, social skills, effectiveness, timeliness, relevance to the meeting, etc.

Participant effectiveness score 604 may additionally/alternatively be generated by the computing system after receiving sensor data 608 automatically collected during meetings. Such sensor data may be collected by one or more of a camera, microphone, and touch sensor, as described above. For example, based on the candidate's body language as detected by a camera, a relative attentiveness of the candidate during the meeting may be determined. The camera may also assess the gestures and/or body language of other participants, in order to determine how the participants reacted to any input provided by the candidate. Similarly, a microphone may be used to evaluate how often the candidate speaks, an emotional content/excitement level of the candidate while speaking, etc. In some implementations, a touch sensor may indicate that the candidate was taking meeting-related notes during the meeting and/or using a shared touch-sensitive device collaboratively with other participants, or alternatively, that the candidate was browsing unrelated material. In general, a variety of sensors may detect a variety of information about a candidate during one or more previous meetings, and such sensor data may be used to calculate a participant effectiveness score.

Aggregated meeting contribution score 600 may additionally/alternatively be generated based on individual meeting performance/contribution scores 610 for meetings in which the candidate has previously participated. For example, an individual meeting score for a particular meeting may reflect the perceived effectiveness/efficiency of the meeting, the meeting's determined energy level, the extent to which the meeting contributed to accomplishing a goal, etc.

An individual meeting score may be calculated in a number of ways. For example, the computing system may receive evaluation data 612 for meetings attended by the candidate, and generate the individual meeting scores based on a processing of that evaluation data. Evaluation data may be provided by meeting participants as described above with respect to FIG. 1, and with respect to calculating participant effectiveness scores. For example, meeting participants may provide evaluations of a meeting as a whole, either before, during, or after the meeting. Such evaluations may cover whether the meeting participant felt that the meeting was well organized, productive, efficient, necessary, began/ended on time, whether it was generally a positive experience, whether meeting resources were available/shared, post-meeting actions assigned, etc. Such evaluations may be packaged into evaluation data 612, and used to calculate the individual meeting score for the meeting.

Individual meeting scores 610 may additionally/alternatively be generated based on a processing of sensor data 614, which may be received by the computing system and automatically collected during meetings attended by the candidate. Again, sensor data may be received from one or more of a camera, microphone, and touch sensor, as well as other available sensors. For example, a camera may be used to track which participants attended a meeting, determine at what time the meeting began/ended, detect body language in order to determine a relative attentiveness/energy level of the meeting participants as a group, etc. Similarly, a microphone may determine how many unique meeting participants spoke during the meeting and the lengths of time each unique participant spent speaking, potentially indicating the amount of successful collaboration that took place between the attending participants. In some implementations, touch sensors and/or telemetry/instrumentation data may be used to determine how long each meeting participant spent using personal computing devices during the meeting, how much collaboration occurred via a shared touch sensitive display, etc. In general, any combination of sensors may detect a variety of applicable information during a meeting, and such information may be used by a computing system to calculate an individual meeting score for the meeting.

It will be appreciated that the aggregated meeting contribution score for a candidate may be generated based on any combination of the factors shown in FIG. 6. For example, aggregated meeting contribution score 600 may be generated based on any of sensor data 602, participant effectiveness score 604, and the individual meeting scores 610 alone, or in combination. In particular, the aggregated meeting contribution score may be generated based on individual meeting scores 610, and further generated based on a participant effectiveness score, or vice versa. Accordingly, an overall meeting score for a candidate may be an effective metric for determining the extent to which the candidate positively contributed to all other meetings the candidate has attended, or a particular subset of meetings. Accordingly, candidate participants with high aggregated meeting contribution scores may be recommended by the computing system for a created collaborative engagement.

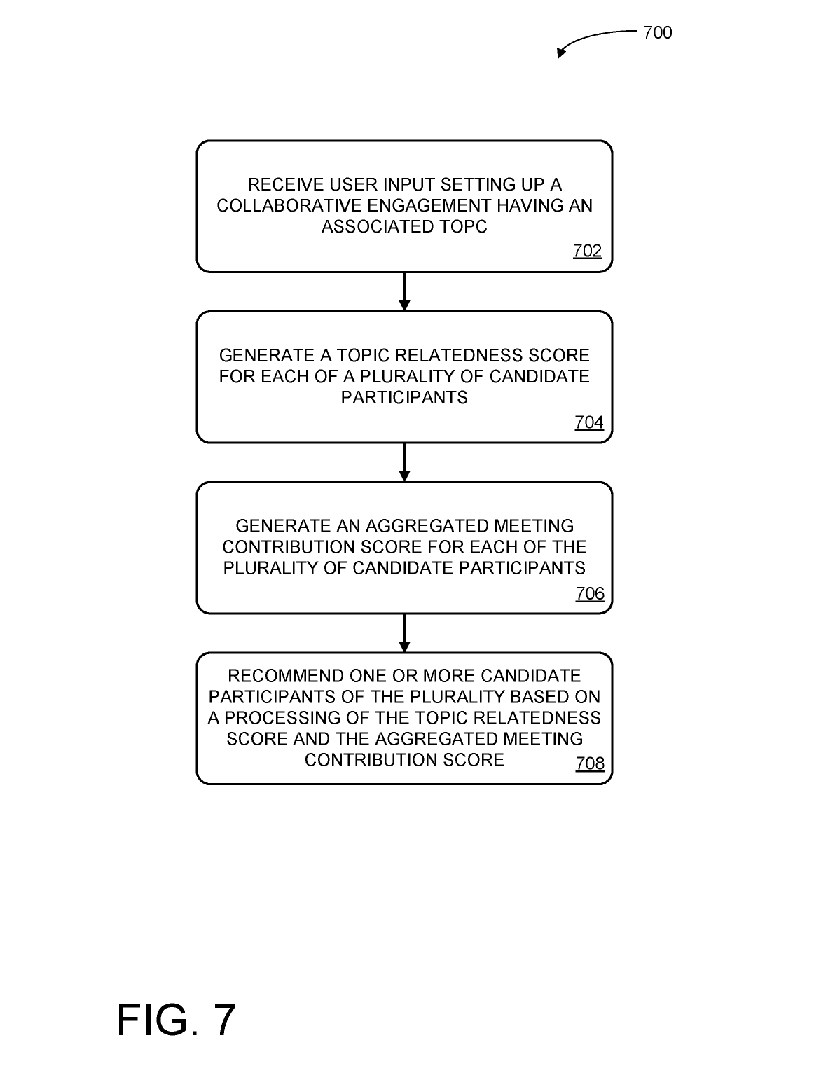

FIG. 7 schematically illustrates an example method 700 for organizing meetings, projects, and other collaborative engagements. At 702, method 700 includes receiving user input setting up a collaborative engagement having an associated topic. As described above, the user input may be provided in a number of suitable ways, and the associated topic may be defined by the user input, and/or automatically inferred by the computing system.

At 704, method 700 includes generating a topic relatedness score for each of a plurality of candidate participants. A topic relatedness score may be generated based on a comparison between the associated topic of a created collaborative engagement and associated topics of collaborative engagements in which a candidate has previously participated. Additionally, or alternatively, a topic relatedness score may be generated based on a comparison between the associated topic of the meeting and a participant expertise profile for the candidate.

At 706, method 700 includes generating an aggregated meeting contribution score for each of the plurality of candidate participants. An aggregated meeting contribution score for a candidate may be generated based on a participant effectiveness score indicating the performance of the candidate during other meetings. Additionally, or alternatively, the aggregated meeting contribution score may be generated based on one or more individual meeting scores for meetings in which the candidate has previously participated. Furthermore, the aggregated meeting contribution score may be generated based on sensor data automatically collected during meetings in which the candidate has previously participated. In some implementations, rather than generating an aggregated meeting contribution score, a computing device may retrieve and/or modify an existing score provided by another source.

At 708, method 700 includes recommending one or more candidate participants based on a processing of the topic relatedness score and the aggregated meeting contribution score. The recommended candidate participants may in some implementations be automatically invited to the collaborative engagement.

In some implementations, a computing system as described herein may use the meeting-related data collected and generated to perform one or more other meeting-related functions. For example, one or more computing systems may collectively provide an organization-wide meeting framework, configured to aid in the organization of meetings and visualization of meeting-related data.

For example, in addition to or as an alternative to recommending candidate participants for a created collaborative engagement, a meeting framework may recommend particular meetings, projects, or other collaborative engagements to users of the meeting framework. Such recommendations may be done in a similar manner to those performed above. For example, associated topics of potential meetings may be compared to a participant expertise profile of the user, and this may serve as the basis for a recommendation. Similarly, the framework may recommend meetings to the user which the user is likely to have a positive impact on, according to a participant effectiveness score, for example.

Upon creation of a collaborative engagement, a user may upload meeting-related materials to the meeting framework. Such materials may then be used to infer the meeting topic, and/or the meeting materials may automatically be distributed to invited participants. Furthermore, the framework may automatically generate additional meeting-related materials, such as an introduction video, for example, based on the user input, associated topic, and any uploaded meeting-related materials.

Further, a meeting framework may collect and evaluate a variety of information associated with any/all meetings that are occurring/have occurred within an organization. Accordingly, the framework may provide valuable organization-wide meeting metrics/metadata. Such data may be used to, for example, identify the most efficient meetings/teams within the organization, identify the meetings/projects that users are most excited about, identify which topics are most widely discussed within the organization, etc.

In some embodiments, the methods and processes described herein may be tied to a computing system of one or more computing devices. In particular, such methods and processes may be implemented as a computer-application program or service, an application-programming interface (API), a library, and/or other computer-program product.

FIG. 8 schematically shows a non-limiting embodiment of a computing system 800 that can enact one or more of the methods and processes described above. In particular, computing system 800 may perform one or more of the collaborative engagement creation and candidate participant recommendation steps described above. Computing system 800 is shown in simplified form. Computing system 800 may take the form of one or more personal computers, server computers, tablet computers, home-entertainment computers, network computing devices, gaming devices, mobile computing devices, mobile communication devices (e.g., smart phone), and/or other computing devices.

Computing system 800 includes a logic machine 802 and a storage machine 804. Computing system 800 may optionally include a display subsystem 806, input subsystem 808, communication subsystem 810, and/or other components not shown in FIG. 8.

Logic machine 802 includes one or more physical devices configured to execute instructions. For example, the logic machine may be configured to execute instructions that are part of one or more applications, services, programs, routines, libraries, objects, components, data structures, or other logical constructs. Such instructions may be implemented to perform a task, implement a data type, transform the state of one or more components, achieve a technical effect, or otherwise arrive at a desired result.

The logic machine may include one or more processors configured to execute software instructions. Additionally or alternatively, the logic machine may include one or more hardware or firmware logic machines configured to execute hardware or firmware instructions. Processors of the logic machine may be single-core or multi-core, and the instructions executed thereon may be configured for sequential, parallel, and/or distributed processing. Individual components of the logic machine optionally may be distributed among two or more separate devices, which may be remotely located and/or configured for coordinated processing. Aspects of the logic machine may be virtualized and executed by remotely accessible, networked computing devices configured in a cloud-computing configuration.

Storage machine 804 includes one or more physical devices configured to hold instructions executable by the logic machine to implement the methods and processes described herein. When such methods and processes are implemented, the state of storage machine 804 may be transformed—e.g., to hold different data.

Storage machine 804 may include removable and/or built-in devices. Storage machine 804 may include optical memory (e.g., CD, DVD, HD-DVD, Blu-Ray Disc, etc.), semiconductor memory (e.g., RAM, EPROM, EEPROM, etc.), and/or magnetic memory (e.g., hard-disk drive, floppy-disk drive, tape drive, MRAM, etc.), among others. Storage machine 804 may include volatile, nonvolatile, dynamic, static, read/write, read-only, random-access, sequential-access, location-addressable, file-addressable, and/or content-addressable devices.

It will be appreciated that storage machine 804 includes one or more physical devices. However, aspects of the instructions described herein alternatively may be propagated by a communication medium (e.g., an electromagnetic signal, an optical signal, etc.) that is not held by a physical device for a finite duration.

Aspects of logic machine 802 and storage machine 804 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 800 implemented to perform a particular function. In some cases, a module, program, or engine may be instantiated via logic machine 802 executing instructions held by storage machine 804. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,”and “engine” may encompass individual or groups of executable files, data files, libraries, drivers, scripts, database records, etc.

It will be appreciated that a “service”, as used herein, is an application program executable across multiple user sessions. A service may be available to one or more system components, programs, and/or other services. In some implementations, a service may run on one or more server-computing devices.

When included, display subsystem 806 may be used to present a visual representation of data held by storage machine 804. This visual representation may take the form of a graphical user interface (GUI). As the herein described methods and processes change the data held by the storage machine, and thus transform the state of the storage machine, the state of display subsystem 806 may likewise be transformed to visually represent changes in the underlying data. Display subsystem 806 may include one or more display devices utilizing virtually any type of technology. Such display devices may be combined with logic machine 802 and/or storage machine 804 in a shared enclosure, or such display devices may be peripheral display devices.

When included, input subsystem 808 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity.

When included, communication subsystem 810 may be configured to communicatively couple computing system 800 with one or more other computing devices. Communication subsystem 810 may include wired and/or wireless communication devices compatible with one or more different communication protocols. As non-limiting examples, the communication subsystem may be configured for communication via a wireless telephone network, or a wired or wireless local- or wide-area network. In some embodiments, the communication subsystem may allow computing system 800 to send and/or receive messages to and/or from other devices via a network such as the Internet.

In an example, a computing system for organizing meetings, projects and other collaborative engagements comprises: a logic machine; and a storage machine holding instructions executable by the logic machine to: receive user input setting up a collaborative engagement, the collaborative engagement having an associated topic; and recommend one or more candidate participants for the collaborative engagement based on a candidate score for each of the one or more candidate participants, the candidate score for a particular candidate participant being computer generated and based on: (1) a topic relatedness score for the particular candidate participant; and (2) an aggregated meeting contribution score for the particular candidate participant. In this example or any other example, the instructions are further executable to generate the topic relatedness score via a comparison between the associated topic and associated topics of meetings in which the particular candidate participant has participated. In this example or any other example, the instructions are further executable to, for each of the candidate participants, generate a participant expertise profile based on information obtained from one or more participant information sources, and generate the topic relatedness score via a comparison between the associated topic and the participant expertise profile. In this example or any other example, the instructions are further executable to generate the aggregated meeting contribution score for the particular candidate participant based on a participant effectiveness score for the particular candidate participant, the participant effectiveness score being calculated for the particular candidate participant based on performance of the particular candidate participant in other meetings. In this example or any other example, the instructions are further executable to receive evaluation data for the particular candidate participant associated with meetings in which the particular candidate participant has previously participated, and generate the participant effectiveness score based on a processing of the evaluation data. In this example or any other example, the instructions are further executable to receive sensor data automatically collected during meetings in which the particular candidate participant has previously participated, and generate the participant effectiveness score based on a processing of the sensor data. In this example or any other example, the instructions are further executable to generate the aggregated meeting contribution score for the particular candidate participant based on individual meeting scores for meetings in which the particular candidate participant has previously participated. In this example or any other example, the instructions are further executable to receive, from meeting participants, evaluation data for meetings in which the particular candidate participant has previously participated, and generate the individual meeting scores for the meetings based on a processing of the evaluation data. In this example or any other example, the instructions are further executable to receive sensor data automatically collected during meetings in which the particular candidate participant has previously participated, and generate the individual meeting scores for the meetings based on a processing of the sensor data. In this example or any other example, the aggregated meeting contribution score for the particular candidate participant is further generated based on a participant effectiveness score for the particular candidate participant. In this example or any other example, the instructions are further executable to receive sensor data automatically collected during meetings in which the particular candidate participant has previously participated, and generate the aggregated meeting contribution score for the particular candidate participant based on a processing of the sensor data. In this example or any other example, the sensor data is received from one or more of a camera, a microphone, and a touch sensor. In this example or any other example, the associated topic is automatically inferred by the computing system based on the received user input. In this example or any other example, the instructions are further executable to automatically invite the one or more recommended candidate participants to the collaborative engagement.

In an example, a method for organizing meetings, projects, and other collaborative engagements comprises: receiving user input setting up a collaborative engagement, the collaborative engagement having an associated topic; for each of a plurality of candidate participants, generating a topic relatedness score; for each of the plurality of candidate participants, generating an aggregated meeting contribution score; and based on a processing of the topic relatedness score and the aggregated meeting contribution score, recommending one or more candidate participants of the plurality of candidate participants for the collaborative engagement. In this example or any other example, generating the aggregated meeting contribution score includes receiving sensor data automatically collected during previous meetings in which a particular candidate participant has previously participated, and generating an aggregated meeting contribution score for the particular candidate participant based on a processing of the sensor data. In this example or any other example, an aggregated meeting contribution score for a particular candidate participant is calculated based on individual meeting scores for meetings in which the particular candidate participant has previously participated. In this example or any other example, the aggregated meeting contribution score for the particular candidate participant is further calculated based on a participant effectiveness score for the particular candidate participant, the participant effectiveness score being calculated for the particular candidate participant based on performance of the particular candidate participant in other meetings.

In an example, a computing system for organizing meetings, projects and other collaborative engagements, comprises: a logic machine; and a storage machine holding instructions executable by the logic machine to: receive user input setting up a collaborative engagement; and recommend one or more candidate participants for the collaborative engagement based on a candidate score for each of the one or more candidate participants, the candidate score for a particular candidate participant being computer generated and calculated based on an aggregated meeting contribution score for the particular candidate participant; where the aggregated meeting contribution score for the particular candidate participant is calculated based on a processing of sensor data automatically collected during meetings in which the particular candidate participant has previously participated; and where the sensor data is received from one or more of a camera, a microphone, and a touch sensor. In this example or any other example, the instructions are further executable to generate the aggregated meeting contribution score for the particular candidate participant based on a participant effectiveness score for the particular candidate participant, and individual meeting quality scores for meetings in which the particular candidate participant has previously participated.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. A computing system for organizing meetings, projects and other collaborative engagements, comprising:
a logic machine; and
a storage machine holding instructions executable by the logic machine to:
receive user input setting up a collaborative engagement, the collaborative engagement having an associated topic; and
recommend one or more candidate participants for the collaborative engagement based on a candidate score for each of the one or more candidate participants, the candidate score for a particular candidate participant being computer generated and based on:
(1) a topic relatedness score for the particular candidate participant; and
(2) an aggregated meeting contribution score for the particular candidate participant.

2. The computing system of claim 1, where the instructions are further executable to generate the topic relatedness score via a comparison between the associated topic and associated topics of meetings in which the particular candidate participant has participated.

3. The computing system of claim 1, where the instructions are further executable to, for each of the candidate participants, generate a participant expertise profile based on information obtained from one or more participant information sources, and generate the topic relatedness score via a comparison between the associated topic and the participant expertise profile.

4. The computing system of claim 1, where the instructions are further executable to generate the aggregated meeting contribution score for the particular candidate participant based on a participant effectiveness score for the particular candidate participant, the participant effectiveness score being calculated for the particular candidate participant based on performance of the particular candidate participant in other meetings.

5. The computing system of claim 4, where the instructions are further executable to receive evaluation data for the particular candidate participant associated with meetings in which the particular candidate participant has previously participated, and generate the participant effectiveness score based on a processing of the evaluation data.

6. The computing system of claim 4, where the instructions are further executable to receive sensor data automatically collected during meetings in which the particular candidate participant has previously participated, and generate the participant effectiveness score based on a processing of the sensor data.

7. The computing system of claim 1, where the instructions are further executable to generate the aggregated meeting contribution score for the particular candidate participant based on individual meeting scores for meetings in which the particular candidate participant has previously participated.

8. The computing system of claim 7, where the instructions are further executable to receive, from meeting participants, evaluation data for meetings in which the particular candidate participant has previously participated, and generate the individual meeting scores for the meetings based on a processing of the evaluation data.

9. The computing system of claim 7, where the instructions are further executable to receive sensor data automatically collected during meetings in which the particular candidate participant has previously participated, and generate the individual meeting scores for the meetings based on a processing of the sensor data.

10. The computing system of claim 7, where the aggregated meeting contribution score for the particular candidate participant is further generated based on a participant effectiveness score for the particular candidate participant.

11. The computing system of claim 1, where the instructions are further executable to receive sensor data automatically collected during meetings in which the particular candidate participant has previously participated, and generate the aggregated meeting contribution score for the particular candidate participant based on a processing of the sensor data.

12. The computing system of claim 11, where the sensor data is received from one or more of a camera, a microphone, and a touch sensor.

13. The computing system of claim 1, where the associated topic is automatically inferred by the computing system based on the received user input.

14. The computing system of claim 1, where the instructions are further executable to automatically invite the one or more recommended candidate participants to the collaborative engagement.

15. A method for organizing meetings, projects, and other collaborative engagements, the method comprising:
receiving user input setting up a collaborative engagement, the collaborative engagement having an associated topic;
for each of a plurality of candidate participants, generating a topic relatedness score;
for each of the plurality of candidate participants, generating an aggregated meeting contribution score; and
based on a processing of the topic relatedness score and the aggregated meeting contribution score, recommending one or more candidate participants of the plurality of candidate participants for the collaborative engagement.

16. The method of claim 15, where generating the aggregated meeting contribution score includes receiving sensor data automatically collected during previous meetings in which a particular candidate participant has previously participated, and generating an aggregated meeting contribution score for the particular candidate participant based on a processing of the sensor data.

17. The method of claim 15, where an aggregated meeting contribution score for a particular candidate participant is calculated based on individual meeting scores for meetings in which the particular candidate participant has previously participated.

18. The method of claim 17, where the aggregated meeting contribution score for the particular candidate participant is further calculated based on a participant effectiveness score for the particular candidate participant, the participant effectiveness score being calculated for the particular candidate participant based on performance of the particular candidate participant in other meetings.

19. A computing system for organizing meetings, projects and other collaborative engagements, comprising:
a logic machine; and
a storage machine holding instructions executable by the logic machine to:
receive user input setting up a collaborative engagement; and
recommend one or more candidate participants for the collaborative engagement based on a candidate score for each of the one or more candidate participants, the candidate score for a particular candidate participant being computer generated and calculated based on an aggregated meeting contribution score for the particular candidate participant;
where the aggregated meeting contribution score for the particular candidate participant is calculated based on a processing of sensor data automatically collected during meetings in which the particular candidate participant has previously participated; and
where the sensor data is received from one or more of a camera, a microphone, and a touch sensor.

20. The computing system of claim 19, where the instructions are further executable to generate the aggregated meeting contribution score for the particular candidate participant based on a participant effectiveness score for the particular candidate participant, and individual meeting quality scores for meetings in which the particular candidate participant has previously participated.
